(19) United States
(12) Patent Application Publication
(10) Pub. No.: US 2016/0129927 A1
(43) Pub. Date: May 12, 2016

(54) Method and Apparatus for Protecting the Contents of a Shopping Cart

(71) Applicants: Keith Auston Russell, Dallas, OR (US); Leah Joann Russell, Dallas, OR (US)

(72) Inventors: Keith Auston Russell, Dallas, OR (US); Leah Joann Russell, Dallas, OR (US)

(21) Appl. No.: 14/927,185

(22) Filed: Oct. 29, 2015

Related U.S. Application Data
(60) Provisional application No. 62/069,965, filed on Oct. 29, 2014.

(51) Int. Cl. B62B 3/14

(52) U.S. Cl. CPC B62B 3/1436; B62B 3/1464

(57) ABSTRACT

A reusable or disposable liner for a shopping cart that protects a user or the user's purchases and belongings from disease pathogens or other harmful materials which may be carried on the cart is provided herein. The liner is secured in position by fasteners that attach at various points around the cart. A pocket is provided for the user's personal belongings. The liner is provided in paper, plastic, and cloth versions.

### CROSS-REFERENCES TO RELATED APPLICATIONS

This application claims priority to U.S. Provisional Patent Application Ser. No. 62/069,965 filed on Oct. 29, 2014 entitled “Liner for shopping cart”, the disclosure of which is hereby incorporated by reference.

### BACKGROUND OF THE INVENTION

The present invention relates to sanitation devices, and more specifically, reusable sanitation devices which prevent the contamination of tangible merchandise.

### BACKGROUND OF THE INVENTION

Personal shopping carts, baskets, hand baskets, buggies, trollies, and the like have become ubiquitous in Western societies. Carts are of great use in a variety of situations, particularly when transporting heavy objects or multiple small goods. The cart serves the needs of pedestrian shoppers, who walk to and from the grocery store, or who take public transportation.

In a typical embodiment, a cart has wheels and a basket or shelf for holding objects for transportation. The cart allows the user to keep their hands free when not interacting with the cart. Additionally, some carts are configured to carry heavy loads that the user may not be able to lift and carry for a long time. In some situations, a shopper uses a personal cart to carry objects to and from a car. In other situations, a shopper uses a personal cart to carry objects to and from their house. However, carts are usually large and bulky; thus difficult to store and carry, and it is common for stores to offer carts and the like to patrons free of charge.

Store-owned carts are generally kept within the confines of the property, and are reused until the service life has elapsed. Within this service life, the cart may see thousands to tens of thousands of patrons transporting merchandise through the retail establishment, and subsequently, to their vehicle. Once the user is finished with the cart, it is a common practice to place the cart into an outdoor corral designed to disallow the carts to freely roam the lot upon the whims of wind gusts or terrain inconsistencies.

Unfortunately, the cart will reside in the outdoor corral until retrieval, which can be several hours. Between the time the cart enters the corral, and when it is retrieved, the cart is subjected to many environmental factors, such as, but not limited to, car exhaust, rain-borne chemical pollutants, molds, and avian fecal matter. These contaminants remain on the surfaces of the cart until the retail establishment takes it upon themselves to clean the entire fleet of carts. Generally, this cleansing is contracted out, or a stand-alone unit is purchased for the establishment at great expense, and as such, is not common. Carts generally go many weeks or months between disinfectant-based cleansings, increasing the likelihood that patrons, food, or merchandise will come into contact with the contaminants residing upon the cart.

Sanitary liners are known within the art. Parents and custodians have become aware of possible contamination issues and thus employ a number of approaches to minimize the spread of germs to an infant or child using an infant seat, shopping cart seat, public high chair, or the like. Some parents simply attempt to disinfect the device by use of disinfectant sprays or products such as disinfectant wipes, which may be carried in a purse or pocket and unpackaged and used to wipe the surfaces. The difficulty with this approach is that it is virtually impossible for the parent or guardian to reach all of the surfaces particularly in an object such as a shopping cart.

In the past, some have proposed shopping cart seat lining devices. Most of these are for the purpose of increasing the comfort or safety of the child. Most embodiments disclose large, cumbersome, child seats, which have restraints and or cushions, but do not effectively shield the cart seat or child from contamination. Further, since these devices are intended for use by many different children, the possibility of food contamination is increased.

Another embodiment discloses a cart seat cover which is made of a soft material, and is designed to conform to and fold over the front, rear, and sides of the seat through flaps which extend from a common bottom. Because of this configuration, which is essentially open along the edges between the flaps, it cannot prevent food contamination.

Another embodiment discloses an anti-bacterial baby seat which describes the problem of the presence of bacteria in a cart from a prior child who might contaminate the cart, but these embodiments seek to protect only the child—not the food in the cart.

The use of shopping cart liners to prevent contamination extends beyond the seated compartment. This method includes providing a shopping cart liner comprising a flexible, plastic liner body having a bottom panel and a rear portion, a pair of side portions and a front portion extending from the bottom panel and at least two liner compartments provided in the liner body; deploying the liner body in the shopping cart; and placing at least one item in at least one of the at least two liner compartments.

Unfortunately, this method ignores the seated compartment, severely limiting the carrying capacity of the cart. Further, the use of non-washable plastic restricts the service life of the liner, requiring the user to purchase additional liners at an unnecessary expense.

It could be said there lies a need for a reusable, washable, and comprehensively-fitting cart liner to prevent the spread of disease and contamination of food.

The present invention meets this need by providing the user with a cloth, paper, or plastic-based washable and re-usable cart liner which employs a plurality of easily-obtained shapes, sizes, and compartmental options.

### BRIEF SUMMARY OF THE INVENTION

The present invention is directed to a reusable or disposable liner for a shopping cart. The liner protects the user or the user's purchases and belongings from disease pathogens which may be carried on the cart. The liner is secured in position by fasteners that attach at various points around the cart. A pocket is provided for the user's personal belongings. The liner is provided in paper, plastic, and cloth versions.

In an embodiment of the present invention, a reusable cloth liner is provided that fits securely within a plurality of compartments of a shopping cart including the grocery compartment and the child seat area. The liner secures to the cart by way of fasteners such as Velcro™ straps. The liner has flaps in the child seat area that open to allow a child to pass his or her legs through the rear of the cart. The flaps snap shut to seal the compartment if no child is present. The liner has a closable pocket that allows users to place personal items such as keys, wallets, or cell phones. The pocket can be snapped shut to prevent loss of the personal items.

In another embodiment of the present invention, a disposable liner for a shopping cart is provided constructed from paper or a paper-like material. The disposable liner fits securely within the grocery compartment of a shopping cart and the and the child seat area of the cart. The disposable liner protects groceries placed in the cart and children occupying the cart from exposure to pathogens, disease, or other harmful contaminants that may be present on cart surfaces.

In yet another embodiment of the present invention, a shopping cart liner is provided that lines the interior of a grocery cart. The liner has a single compartment covering that lines only the grocery area of the cart and is designed to be used with carts that do not have a child seat area. The liner fastens to the cart by way of elastic bands that loop around portions of the cart.

Other novel features which are characteristics of the invention, as to organization and method of operation, together with further and advantages thereof will be better understood from the following description considered in connection with the accompanying figures, in which preferred embodiments of the invention are illustrated by way of example. It is to be expressly understood, however, that the figures are for illustration and description only and are not intended as a definition of the limits of the invention. The various features of novelty which characterize the invention are pointed out with particularity in the following description. The invention resides not in any one of these features taken alone, but rather in the particular combination of all of its structures for the functions specified.

### BRIEF DESCRIPTION OF THE FIGURES

FIG. 1 is a perspective view of a protective cart liner installed within a shopping cart as according to an embodiment of the present invention;

FIG. 2 is a top view of a protective cart liner installed within a shopping cart containing groceries as according to an embodiment of the present invention;

FIG. 3 is a left side view of a protective cart liner installed within a shopping cart as according to an embodiment of the present invention;

FIG. 4 is a right side view of a protective cart liner installed within a shopping cart as according to an embodiment of the present invention;

FIG. 5 is a perspective view of a protective cart liner as according to an embodiment of the present invention;

FIG. 6 is a front view of a rear panel of a protective cart liner containing an area for a child's legs to pass through when a child occupies a shopping cart as according to an embodiment of the present invention;

FIG. 7 is a front view of a side panel of a protective cart liner as according to an embodiment of the present invention;

FIG. 8 is a front view of a side panel of a protective cart liner as according to an embodiment of the present invention; and

FIG. 9 is a front view of a pocket of a protective cart liner that can contain personal items of a user as according to an embodiment of the present invention.

A further understanding of the present invention can be obtained by reference to a preferred embodiment set forth in the accompanying description. Although the illustrated embodiments are merely exemplary of methods for carrying out the present invention, both the organization and method of operation of the invention, in general, together with further objectives and advantages thereof, may be more easily understood by reference to the illustrations and the following description. The figures are not intended to limit the scope of this invention, but merely to clarify and exemplify the invention.

### DETAILED DESCRIPTION OF THE INVENTION

In the following detailed description, reference is made to specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method(s) or apparatus include the discussed feature, advantage or mode of operation. The following description of the preferred embodiment is merely exemplary in nature and is in no way intended to limit the invention, its application, or use.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter. Those skilled in the art will appreciate that the conception upon which this disclosure is based may be readily utilized as a basis for the designing of other structures, methods and systems for carrying out the purposes of the present invention. It is important, therefore, that any embodiments of the present invention be regarded as including such equivalent constructions insofar as they do not depart from the spirit and scope of the present invention.

Further, the purpose of the Abstract herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

Referring now to the present invention, there is introduced a method and apparatus for protecting the contents of a shopping cart comprised providing a plurality of panels that, when taken together, form a liner for protecting the contents of a shopping cart as according to an embodiment of the present invention. For the purpose of clarity, all like elements mentioned in this description will have the same designations. The terms “method and apparatus for protecting the contents of a shopping cart”, “liner”, “method”, “apparatus”, “invention”, “present invention” and similar terms may be used interchangeably. In addition to the functions, features, components, and abilities of the invention already discussed in this specification, the invention may also have, but not be limited to, the following features contained within the description below.

The present invention solves the shortcomings of the prior art by providing a method and apparatus for protecting the contents of a shopping cart from contamination by foreign objects or material, such as viruses, germs, toxins and the like, that may be residing on the surfaces of a shopping cart. The preferred embodiments described below set forth the present invention in greater detail.

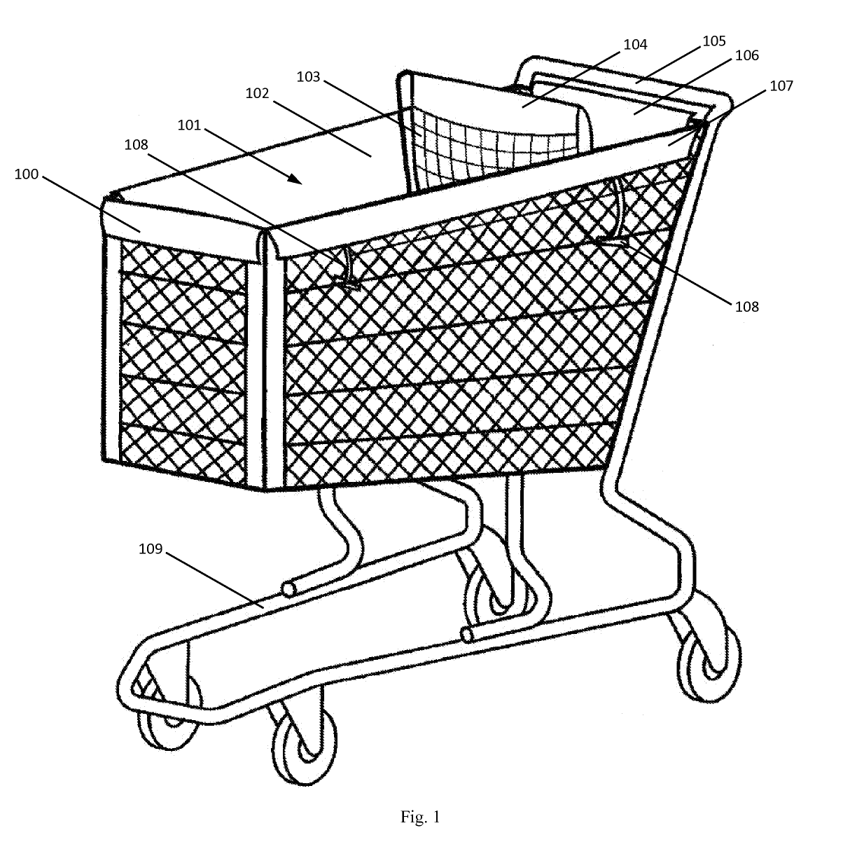

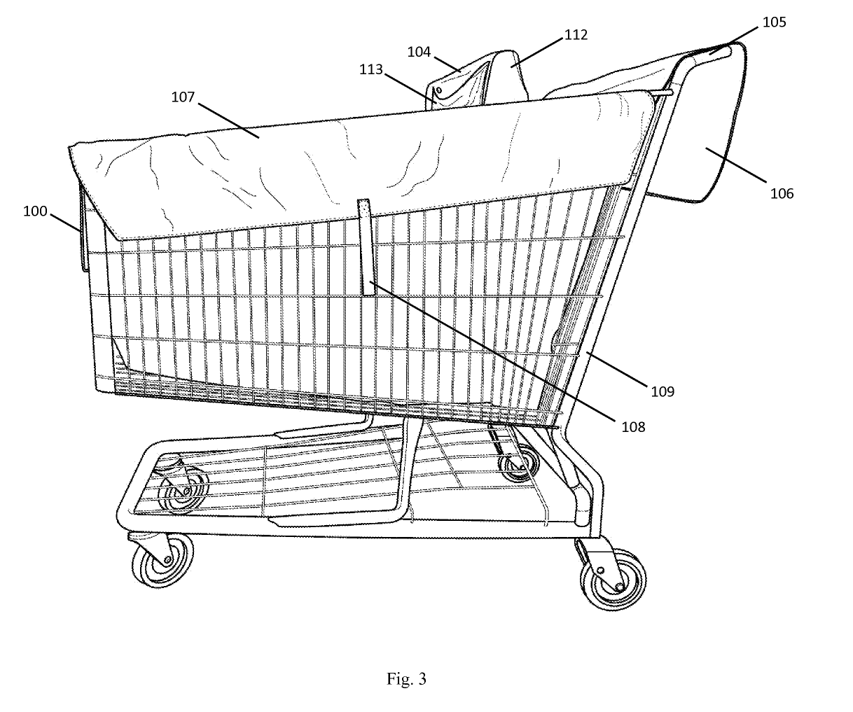

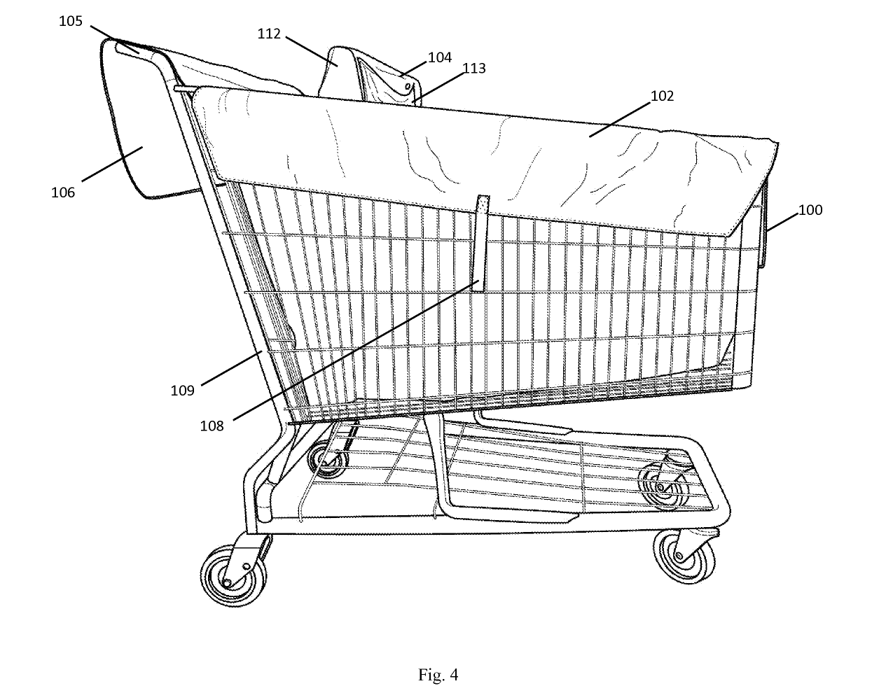

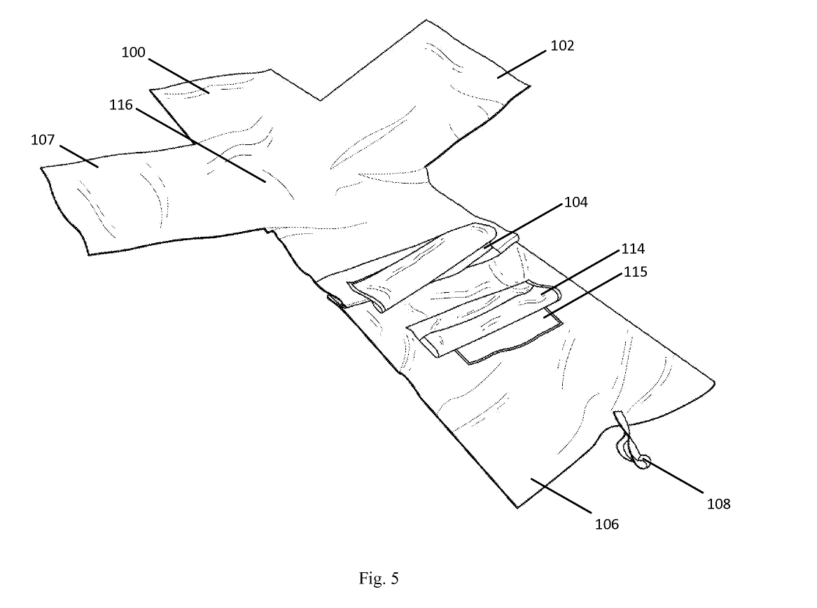

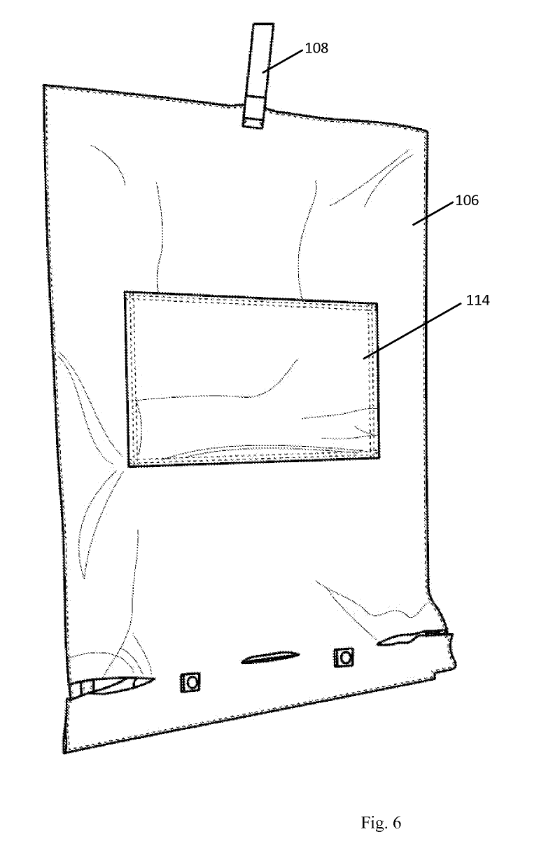

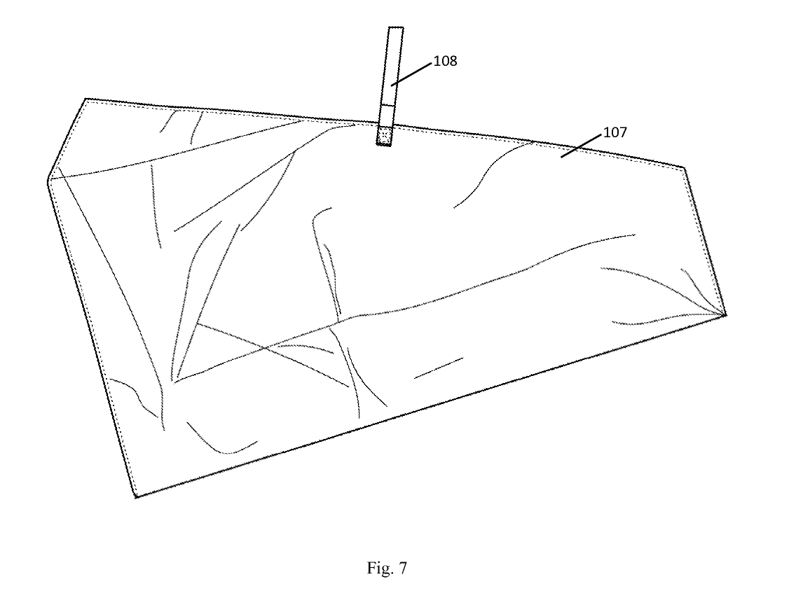

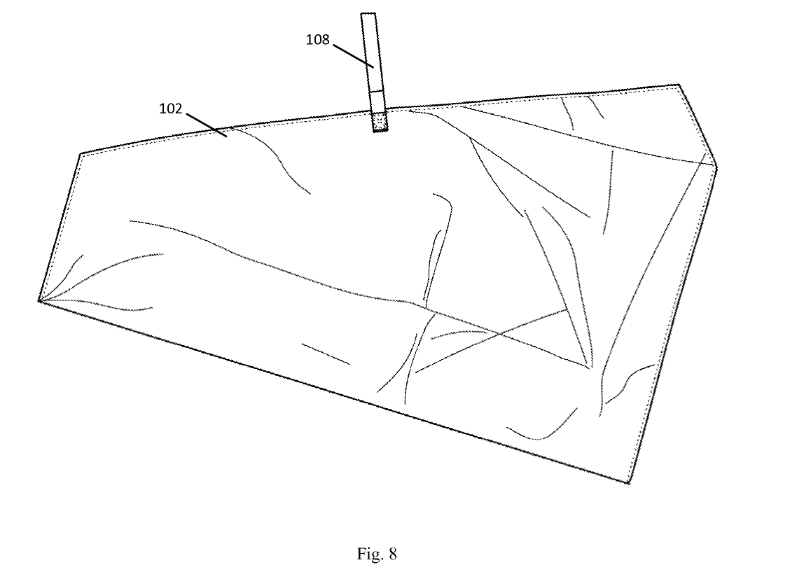

Referring now to FIGS. 1-9 that will be discussed together, there are shown views of a method and apparatus for protecting the contents of a shopping cart (109) as according to an embodiment of the present invention. One embodiment of the present invention provides an apparatus generally comprised of a plurality of panels that, when attached to each other, form a liner that lines the interior of a shopping cart (109). The panels are shaped and constructed so that they snugly fit over the components found within the shopping cart (109). The panels are further shaped so that the invention can be easily secured to, and removed from, the shopping cart (109). The panels are secured to the cart (109) in a way that allows them to cover the bottom of the cart (109), extend up the sides and front of the cart (109), and to cover the child seating area and compartment divider if a cart (109) is so provided. It should be noted that although this description sets for the present invention in terms of panels that, when taken together, form embodiments of a protective shopping cart liner, some embodiments may provide a liner as according to the present invention that is unibody. That is, some embodiments of the present invention may be constructed from a single piece of material that is so shaped as to properly fit within a shopping cart (109). In these embodiments, the internal compartment (101) of the shopping cart (109) is covered by different areas of the liner. The front wall of the shopping cart (109) is covered by the front area of the liner, the left wall of the cart (109) is covered by the left area of the liner, the right wall of the cart (109) is covered by the right area of the liner, the bottom of the cart (109) is covered by a bottom area of the cart, and the rear area of the cart (109) is covered by the rear area of the liner.

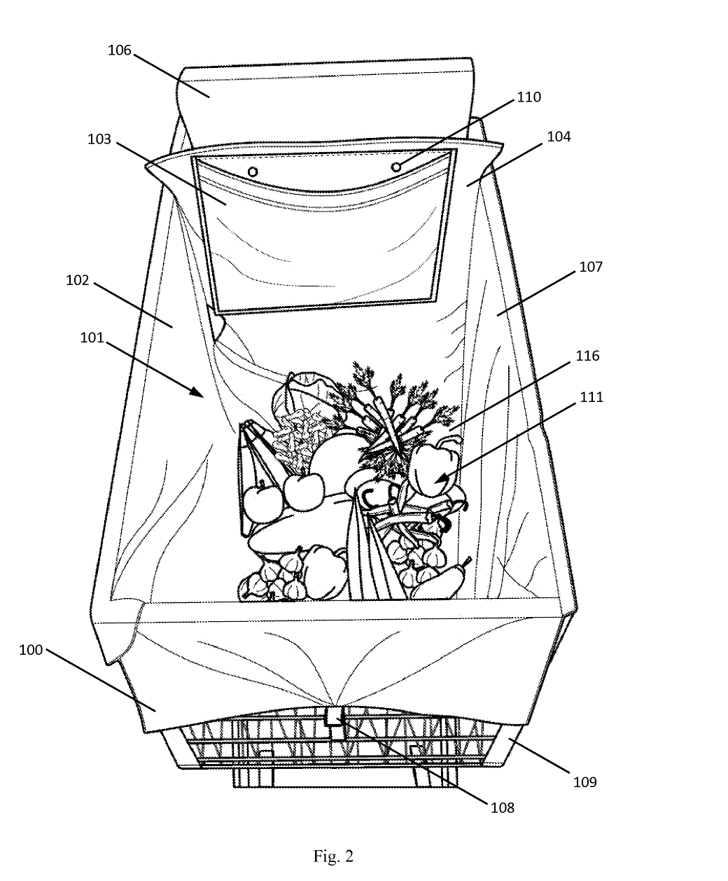

In one embodiment of the present invention, a front panel (100) extends from the bottom panel (116) of the interior compartment (101) of a shopping cart (109) to the top of the front panel of the cart (109). The front panel (100) is shaped so that it covers the front wall of the shopping cart (109) and is attached on either side to a left side panel (107) and a right side panel (102) of the liner. The front panel (100) is also attached to a bottom panel (116) of the liner. Some embodiments of the present invention provide a front panel (100) that extends up and over the front wall of the shopping cart (109) with excess material extending down the exterior of the front wall of the cart (109). This area of excess material may be used by these embodiments to provide a securement area of the front panel (100) that is used to secure the front panel (100) to the shopping cart (109) by way of a fastener (108) as illustrated in FIG. 2. Other embodiments of the present invention may provide only an overlap of excess front panel (100) material with no fastener (108), as illustrated in FIG. 1, while still other embodiments may provide a front panel (100) with no excess material.

The left and right panels (107) and (102), respectively, are shaped so that they cover the left and right walls of the interior compartment (101) of a shopping cart (109). The left (107) and right (102) panels are connected along one side to the front panel (100), along another side to the bottom panel (116), and along another side to a rear panel (106) of the shopping cart liner. In some embodiments of the present invention, the left (107) and right (102) panels allow a cart separator covering panel (104), if the shopping cart (109) possess a separator component (112) that separates the interior compartment (101) of the cart (109) from a child seating area of the cart (109), to reside between them. The separator component (112) is generally a metal construct that extends from the bottom of the shopping cart (109) near vertically out of the top of the cart (109) and can be folded or slid toward the rear of the cart (109) if a child is not present or if more space in the cart (109) is required.

The left (107) and right (102) panels can extend out of the cart (109) so as to provide attachment areas for securing the liner to the shopping cart (109) by way of fasteners (108). The fasteners (108) secure the left (107) and right (102) panels to the shopping cart (109) to keep the liner in place and properly fitting. As with the front panel (100), some embodiments of the present invention may not include excess material of the left (107) and right (102) panels that extend out of the cart (109), or may not use fasteners (108) to secure the left and right panels to the cart (109).

The cart separator covering panel (104) is the component of the present invention that covers a shopping cart separator component (112) that separates the interior compartment (101) of a shopping cart (109) where groceries (111) or other types of items such as clothing, household goods, and the like, are held from a child seating area if the shopping cart (109) is provided with a child seating area. It is important to note that some shopping carts (109) are not provided with a child seating area and thus do not contain a separator component (112). For these type of carts (109), embodiments of the present invention are constructed without the cart separator covering panel (104).

Embodiments of the present invention that provide a cart separator covering panel (104) can also, but are not required to, provide a personal goods compartment (103) that houses the personal goods of a user. The personal goods compartment (103) can be used to hold cell-phones, keys, wallets, shopping lists, or any other item that a user has with them or does not wish to lose when shopping. The personal goods compartment (103) is sealable by way of snaps (110) that can be snapped closed after items are placed into the compartment (103).

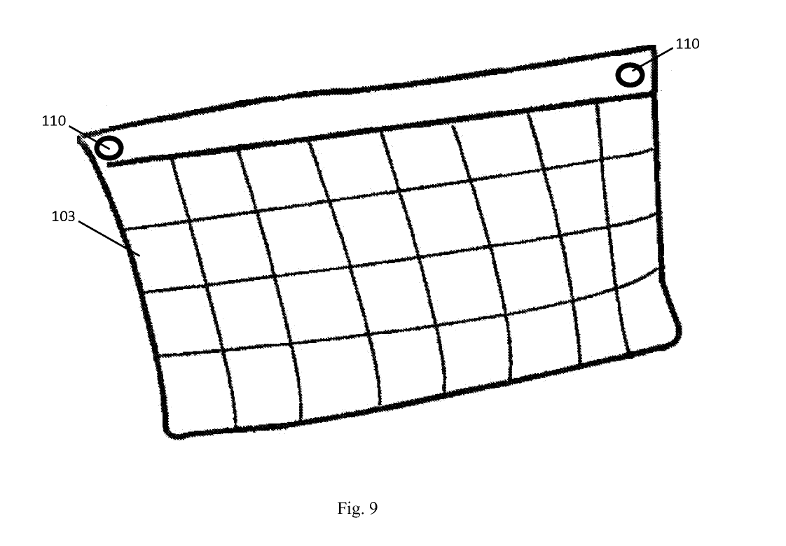

The personal goods compartment (103) can be a solid piece of material as shown in FIG. 2, or can be constructed of a mesh material as shown in FIG. 9. Furthermore, although snaps (110) are shown as the component that seals the personal goods compartment (103), it is possible for other types of components to be used for the purpose of sealing the personal goods compartment (103) such as Velcro™ or bungee.

The cart separator component (104) that contains the personal goods compartment (103) is attached along its bottom to the bottom panel (116) or the rear panel (106) of the liner. The rear panel (106) of the liner is the component of the present invention that covers either the rear wall of the shopping cart (109), or covers the child seating area of the cart (109) if the cart (109) is equipped with a child seating area. If the cart (109) is equipped with a child seating area, the rear panel (106) can be provided with a leg cutout (115) so that the legs of a child may extend out of the cart when the child is seated in the child seated area. If a child is not seated in the child seating area, a leg cutout cover (114) can be used to close the cutout (115). The cover (114) can be held in place by snaps (110), Velcro™, or any other type of fastener that is capable of holding the cover (114) in a closed position. It should be noted that embodiments of the present invention adapted for use in carts (109) without a child seating area may be provided with a rear panel (106) that does not contain a leg cutout (115) or a leg cutout cover (114). Furthermore, some embodiments of the present invention may provide a rear panel (106) that is attached to the cart (109) by way of a fastener (108) located along one side of the rear panel (106).

Some embodiments of the present invention provide a rear panel (106) constructed so that it covers the handle (105) of the shopping cart as shown in FIGS. 2-4. However, some embodiments of the present invention provide a rear panel (106) that does not cover the rear handle (105) as shown in FIG. 1. In these embodiments, the rear panel (106) can pass underneath the handle (105) and down the backside of the rear wall so that the rear panel (106) can be fastened to the cart (109).

The fasteners (108) used to secure the liner to the cart (109) can be any fastener capable of securing the liner to a shopping cart (109). Some embodiments use Velcro Straps™ as shown in FIGS. 2-8 while other embodiments can use bungee straps as shown in FIG. 1. The fasteners (108) are designed so that the liner is quickly and easily installed prior to use of the cart (109) by a user, then quickly and easily removed after use by a user. The fasteners (108) are designed to be quickly and easily installed and removed because the liner is reusable and transferrable from cart (109) to cart (109).

Although some embodiments of the present invention provide a liner that is transferrable and reusable, other embodiments provide a liner that is intended to be used once or only a few times and can be considered disposable. These one-use embodiments still possess some or all of the features as the reusable embodiments depending on the nature and circumstances of each use-case.

Embodiments of the present invention are constructed from material that keeps a user and groceries (111) safe from contamination by foreign matter residing on the surfaces of the cart (109). The materials used to construct the liner can include, but is not limited to, paper, cloth, plastics, or other similar pliable materials that can conform to the shape of a shopping cart (109).

There are described and illustrated new and improved method and apparatus for protecting the contents of a shopping cart, and methods for formulating the method and apparatus for protecting the contents of a shopping cart. The inventive portions of the method and apparatus for protecting the contents of a shopping cart include several components and steps that, when taken together, constitute an embodiment of the present invention. The above detailed description sets forth rather broadly the more important features of the present invention in order that its contributions to the art may be better appreciated.

As such, those skilled in the art will appreciate that the conception, upon which disclosure is based, may readily be utilized as a basis for designing other structures, methods, and systems for carrying out the several purposes of the present invention. It is important, therefore, that this description be regarded as including such equivalent constructions insofar as they do not depart from the spirit and scope of the present invention.

Although certain example methods, apparatus, apparatus and articles of manufacture have been described herein, the scope of coverage of this application is not limited thereto. On the contrary, this application covers all methods, apparatus and articles of manufacture fairly falling within the scope of the invention either literally or under the doctrine of equivalents.

Directional terms such as “front”, “forward”, “back”, “rear”, “in”, “out”, “downward”, “upper”, “lower”, “top”, “bottom”, “upper”, “lower”, “left”, “right” and the like have been used in the description. These terms are applicable to the embodiments shown and described herein. These terms are merely used for the purpose of description and do not necessarily apply to the position in which components or items within the present invention may be used.

Therefore, the foregoing is considered as illustrative only of the principles of a method and apparatus for protecting the contents or user of a shopping cart. Further, since numerous modifications and changes will readily occur to those skilled in the art, it is not desired to limit the method and apparatus for protecting the contents or user of a shopping cart to the exact construction and operation described, and accordingly, all suitable modifications and equivalents may be resorted to, falling within the scope of the present invention. While the above description describes various embodiments of the present invention, it will be clear that the present invention may be otherwise easily adapted to fit other configurations.

As various changes could be made in the above constructions without departing from the scope of the invention, it is intended that all matter contained in the above description shall be interpreted as illustrative and not in a limiting sense.

We claim:

1. An apparatus comprising:
a front area, a left area, a right area, a rear area, and a bottom area;
wherein the front area covers the interior of the front wall of a shopping cart, the left area covers the interior of the left wall of the shopping cart, the right area covers the interior of the right wall of the shopping cart, the rear area covers the interior of the rear area of the shopping cart, and the bottom area covers the interior of the bottom of the shopping cart;
wherein the front area is connected to the left area, right area and the bottom area;
wherein the left area is connected to the front area, the bottom area, and the rear area;
wherein the right area is connected to the front area, the bottom area, and the rear area;
wherein the rear area is connected to the left area, the right area, and the rear area; and
wherein the front area, left area, right area, and rear area are attached to the shopping cart by way of fasteners, at least one fastener being attached to each of the aforementioned areas.

2. The apparatus of claim 1, further comprising a cart separator covering panel that covers a separator component of a shopping cart.

3. The apparatus of claim 2, further comprising a personal goods compartment attached to the separator covering panel.

4. The apparatus of claim 3, wherein the personal goods compartment is sealable.

5. The apparatus of claim 1, wherein the rear area covers the handle of the shopping cart.

6. The apparatus of claim 5, wherein the rear area contains a leg cutout that allows an occupant of the cart to extend their legs through the rear area.

7. The apparatus of claim 6, further comprising a leg cutout cover that can be closed to cover the leg cutout.

8. An apparatus for lining a shopping cart comprising:
a front panel, a left panel, a right panel, a rear panel, a bottom panel, and a cart separator covering panel;
wherein the front panel is attached to the left panel, the right panel, and the bottom panel;
wherein the left panel is attached to the front panel, the bottom panel, and the rear panel;
wherein the right panel is attached to the front panel, the bottom panel, and the rear panel;
wherein the rear panel is attached to the left panel, the right panel, and the cart separator covering panel;
wherein the bottom panel is attached to the front panel, the left panel, the right panel, and the cart separator covering area;
wherein the cart separator covering panel is attached to the bottom panel and the rear panel;
and wherein the front panel, left panel, right panel, and rear panel are attached to fasteners, the fasteners detachably attaching to the shopping cart.

9. The apparatus of claim 8, further comprising excess areas on the front panel, the left panel, the right panel, and the rear panel that extend over and down part of the walls of the shopping cart.

10. The apparatus of claim 8, further comprising a sealable personal goods compartment attached to the cart separator covering panel.

11. The apparatus of claim 9, wherein the sealable personal goods compartment is sealed by way of snaps.

12. The apparatus of claim 9 wherein the sealable personal goods compartment is made from a solid piece of material or from a mesh.

13. The apparatus of claim 8, further comprising a leg cutout formed into the rear panel.

14. The apparatus of claim 12, further comprising a leg cutout cover that can cover the leg cutout when the leg cutout is not being used.

15. A method for lining the interior of a shopping cart comprising:
providing a front panel, a left panel, a right panel, a bottom panel, a rear panel, and a cart separator covering panel;
shaping the front panel so that it covers the interior of the front wall of the shopping cart, shaping the left panel so that it covers the interior of the left wall of the shopping cart, shaping the right panel so that it covers the interior of the right wall of the shopping cart, shaping the bottom panel so that it covers the interior of the bottom of the shopping cart, shaping the rear panel so that it covers the interior of the rear wall of the shopping cart, and shaping the cart separator panel so that it covers a separator component of the shopping cart;
attaching the front panel to the left panel, the right panel, and the bottom panel, attaching the left panel to the bottom panel and the rear panel, attaching the right panel to the bottom panel and the rear panel, attaching the cart separator covering panel to the bottom panel and the rear panel, and attaching the front panel, the left panel, right panel, and the rear panel to fasteners;
wherein the fasteners detachably attach to the shopping cart.

16. The method of claim 15, further comprising providing a personal goods compartment;

17. The method of claim 16, further comprising attaching the personal goods compartment to the cart separator panel.

18. The method of claim 17, further comprising constructing the personal goods compartment from a solid piece of material or a mesh material.

19. The method of claim 15, further comprising attaching a single fastener to each of the front panel, the left panel, the right panel, and the rear panel.

20. The method of claim 15, further comprising constructing the front panel, the left panel, the right panel, the bottom panel, the rear panel, and the cart separator panel from cloth, paper, or plastic.
